(19) United States
(12) Patent Application Publication
(10) Pub. No.: US 2023/0192513 A1
(43) Pub. Date: Jun. 22, 2023

(54) MEMBRANE DISTILLATION SYSTEM WITH GAS BUBBLE SOURCE AND METHOD OF USE

(71) Applicant: Saudi Arabian Oil Company, Dhahran (SA)

(72) Inventors: Hasan Al Abdulgader, Dammam (SA); Seung-Hak Choi, Dhahran (SA)

(21) Appl. No.: 17/556,087

(22) Filed: Dec. 20, 2021

(51) Int. Cl. C02F 1/44; B01D 61/36; B01D 63/04; B01D 69/02; B01D 65/08

(52) U.S. Cl. CPC C02F 1/447; B01D 61/364; B01D 61/366; B01D 61/368; B01D 63/046; B01D 69/02; B01D 65/08; C02F 2103/08

(57) ABSTRACT

A membrane distillation system includes a hollow fiber aerator configured to provide gas bubbles to a relatively cool permeate stream so that the relatively cool permeate stream contains gas bubbles when it contacts a porous and hydrophobic membrane in a direct contact membrane distillation process. The system can further include an additional hollow fiber aerator configured to provide gas bubbles to a relatively hot feed stream so that the relatively hot feed stream contains gas bubbles when it contacts a porous and hydrophobic membrane in a direct contact membrane distillation process.

### FIELD

The disclosure relates to a membrane distillation system with a gas bubble source, such as a hollow fiber aerator, and a method of using such a system.

### BACKGROUND

In general, membrane distillation (MD) involves flowing a relatively hot feed stream along one side of a porous and hydrophobic membrane while counter-flowing a relatively cool permeate stream along the opposite side of the membrane. Typically, the membrane is microporous or mesoporous. The temperature difference between the two streams results in a partial pressure difference across the membrane. The partial pressure difference and the porous nature of the membrane allow water vapor to pass across the membrane from the relatively hot feed stream to the relatively cool permeate stream, where the water condenses to form liquid water in the permeate stream. At the same time, the hydrophobic nature of the membrane generally stops liquid water from passing directly through the membrane. The net result is a transfer of water from the feed stream to the permeate stream.

### SUMMARY

The disclosure provides a membrane distillation system having a gas bubble source, such as a hollow fiber aerator, and a method of using the system.

The gas bubble source can be on the permeate side of the system such that the permeate stream contains bubbles as it contacts the membrane. In general, the membrane is contained in a module of the system. In some embodiments, the gas bubble source is outside the module, such as upstream of the permeate stream inlet of the module. In certain embodiments, the gas bubble source is embedded within the module, such as between the permeate inlet of the module and the membrane along the flow path of the permeate stream inside the module. Without wishing to be bound by theory, it is believed that the gas bubbles in the permeate stream can enhance mass transfer in the permeate stream, which can reduce heat transfer through the boundary layer of the permeate stream at the membrane surface. In other words, the gas bubbles are believed to reduce temperature polarization on the permeate side of the system. Also without wishing to be bound by theory, it is believed that the gas bubbles can reduce membrane fouling on the permeate side of the system. The result can be improved performance of the system.

Additionally or alternatively, the system can include a gas bubble source, such as a hollow fiber aerator, on the feed stream side of the system such that the feed stream contains bubbles as it contacts the membrane. In some embodiments, the gas bubble source is outside the module, such as upstream of the feed stream inlet of the module. In certain embodiments, the gas bubble source is embedded within the module, such as between the feed stream inlet of the module and the membrane along the flow path of the feed stream inside the module. Without wishing to be bound by theory, it is believed that the gas bubbles can enhance mass transfer in the feed stream, which can reduce heat transfer and enhance mass transfer through the boundary layer of the feed stream at the membrane surface, thereby reducing temperature polarization and concentration polarization on the feed stream side of the system. It is also believed that the gas bubbles can reduce fouling of the feed stream side of the system. The result can be improved performance of the system.

The membrane distillation system can be selected as desired. Examples of membrane distillation systems include direct contact membrane distillation (DCMD) systems, vacuum membrane distillation (VIVID) systems, air gap membrane distillation (AGMD) systems, and sweeping gas membrane distillation (SGMD) systems.

A membrane distillation system can be used in a variety of commercial processes, such as water desalination, water treatment, water purification and water reuse. In some embodiments, a membrane distillation process can be used to treat produced water. In such methods, the feed stream is formed of produced water (e.g., with a relatively high saline content), and the permeate stream is formed of relatively pure water. In certain embodiments, a membrane distillation process can be used to treat wastewater. In such methods, the feed stream is formed of wastewater containing various contaminants, and the permeate stream is formed of relatively pure water. In some embodiments, a membrane distillation process can be used in water desalination. In such methods, the feed stream is formed of water with a relatively high saline content, and the permeate stream is formed of relatively pure water.

In a general aspect, the disclosure provides a membrane distillation system. The system includes a housing, which houses a first container configured to allow a first liquid stream to pass therethrough, and also houses a second container configured to allow a second liquid stream to pass therethrough. The second container is different from the first container, and the second stream is different from the first liquid stream. The system further includes a hydrophobic and porous membrane configured so that, during use of the system, the first liquid stream contacts a first side of the membrane and the second liquid stream contacts a second side of the membrane which is different from the first side of the membrane. Moreover, the system further a first device configured to provide gas bubbles to the first liquid stream so that gas bubbles are present in the first liquid stream when the first liquid stream contacts the first side of the membrane. In addition, the system includes a second device configured to provide gas bubbles to the second liquid stream so that, during use of the system, the second liquid stream comprises gas bubbles when the second liquid stream contacts the second side of the membrane. The system is configured so that, during use of the membrane distillation system, the second liquid stream is hotter than the first liquid stream. The gas bubbles in the second liquid stream reduce temperature polarization of the second liquid stream, and the gas bubbles in the second liquid stream reduce concentration polarization of the second liquid stream.

In some embodiments, the first device is a hollow fiber aerator includes a plurality of hollow fibers, and/or the second device is a hollow fiber aerator includes a plurality of hollow fibers. Optionally, each can hollow fiber includes a wall with pores having an average size of from 0.02 μm to 2 μm, and/or the pores can define from 5% to 60% of the surface area of the wall.

In certain embodiments, the system is a direct contact membrane distillation system.

In some embodiments, the first device is in the housing and/or the second device is in the housing.

In certain embodiments, the system is configured so that, during use of the system, the gas bubbles in the first liquid stream reduce temperature polarization of the first liquid stream.

In some embodiments, the gas bubbles have an average size of from 50 μm to 300 μm.

In certain embodiments, the membrane includes a polymer with pores having an average size of from 0.02 μm to 2 μm.

In a general aspect, the disclosure provides a membrane distillation system. The system includes a housing that houses: a first container configured to allow a first liquid stream to pass therethrough; a second container configured to allow a second liquid stream to pass therethrough, the second container being different from the first container, the second stream being different from the first liquid stream; a hydrophobic and porous membrane configured so that, during use of the system, the first liquid stream contacts a first side of the membrane and the second liquid stream contacts a second side of the membrane which is different from the first side of the membrane; a first hollow fiber aerator configured to provide gas bubbles to the first liquid stream so that gas bubbles are present in the first liquid stream when the first liquid stream contacts the first side of the membrane; and a second hollow fiber aerator configured to provide gas bubbles to the second liquid stream so that gas bubbles are present in the second liquid stream when the second liquid stream contacts the first side of the membrane. The membrane distillation system is a direct contact membrane distillation system configured so that, during use of the direct contact membrane distillation system, the second liquid stream is hotter than the first liquid stream. The gas bubbles in the second liquid stream reduce temperature polarization of the second liquid stream, and the gas bubbles in the second liquid stream reduce concentration polarization of the second liquid stream.

In a general aspect, the disclosure provides a method that includes introducing gas bubbles into a first liquid stream, and introducing gas bubbles into a second liquid stream different from the first liquid stream. The second liquid stream is hotter than the first liquid stream. The method also includes, after introducing gas bubbles into the first and second liquid streams, contacting a first side of a hydrophobic and porous membrane with the first liquid stream comprising the gas bubbles while simultaneously contacting a second side of the hydrophobic and porous membrane with the second liquid stream comprising gas bubbles. The first side of the membrane is opposite from the second side of the membrane. The gas bubbles in the second liquid stream reduce a temperature polarization in the second liquid stream, and the gas bubbles in the second liquid stream reduce a concentration polarization in the second liquid stream.

In some embodiments, the method further includes using a hollow fiber aerator to introduce the gas bubbles into the first liquid stream, and/or using a hollow fiber aerator to introduce the gas bubbles into the first liquid stream.

In certain embodiments, the method is used to treat produced water.

In some embodiments, the method is in a produced water desalination process.

### BRIEF DESCRIPTION OF THE FIGURES

FIG. 1 is a schematic drawing of an embodiment of a direct contact membrane distillation system.

FIG. 2 is a schematic drawing of an embodiment of a direct contact membrane distillation system.

FIG. 3 is a schematic drawing of an embodiment of a hollow fiber aerator.

FIG. 4A is a perspective view of a hollow fiber.

FIG. 4B is a cross-sectional view of the hollow fiber of FIG. 4A taken along line 4B.

FIG. 5 is a schematic drawing of an embodiment of a hollow fiber aerator.

FIGS. 6A and 6B schematically depict the potential impact of air bubbles in the feed and permeate streams.

### DETAILED DESCRIPTION

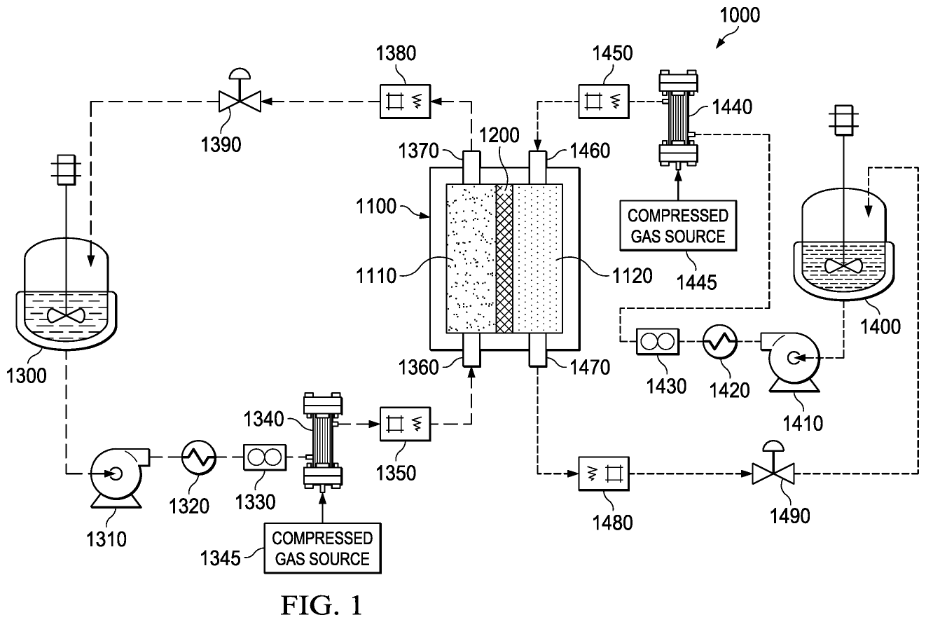

FIG. 1 is a schematic drawing of a direct contact membrane distillation system 1000 that includes a module 1100 that holds a porous and hydrophobic membrane 1200 between a feed stream side 1110 of the module 1100 and a permeate stream side 1120 of the module 1100.

The sequence of the components along the flow path of the feed stream through the system 1000 is a feed tank 1300, a pump 1310 to provide the pressure to cause the feed stream to flow along its path, a heat exchanger 1320 to achieve a desired temperature for the feed stream (e.g., to ensure that the feed stream is hot relative to the permeate stream), a flow meter 1330 to measure the flow rate of the feed stream, a hollow fiber aerator 1340 with a compressed gas (e.g. air) source 1345 to provide air bubbles into the feed stream, a module 1350 for measuring the temperature and pressure of the feed stream, an inlet 1360 on the feed side 1110 of the module 1100, an outlet 1370 on the feed side 1110 of the module 1100, a module 1380 for measuring the pressure and temperature of the feed stream, a back pressure regulator 1390 to regulate the pressure of the feed stream, and the feed tank 1300. In general, as known to those skilled in the art, the relative positions of certain components along the flow path of the feed stream can be changed as appropriate. Generally, the hollow fiber aerator 1340 should be positioned in the feed stream flow path such that it is relatively close to the membrane 1200 along the feed stream flow path, e.g., relatively close to the inlet 1360.

The sequence of the components along the flow path of the permeate stream through the system 1000 is a permeate tank 1400, a pump 1410 to provide the pressure to cause the permeate stream to flow along its path, a heat exchanger 1420 to achieve a desired temperature of the permeate stream (e.g., to ensure that the permeate stream is cool relative to the feed stream), a flow meter 1430 to measure the flow rate of the permeate stream, a hollow fiber aerator 1440 with a compressed gas (e.g. air) source 1445 to provide air bubbles into the permeate stream, a module 1450 for measuring the temperature and pressure of the permeate stream, an inlet 1460 on the permeate stream side 1120 of the module 1100, an outlet 1470 on the permeate stream side 1120 of the module 1100, a module 1480 for measuring the temperature and pressure of the permeate stream, a back pressure regulator 1490 to regulate the pressure of the permeate stream, and the permeate tank 1400. In general, as known to those skilled in the art, the relative positions of certain components along the flow path of the permeate stream can be changed as appropriate. Generally, the hollow fiber aerator 1440 should be positioned in the permeate stream flow path such that it is relatively close to the membrane 1200 along the permeate stream flow path, e.g., relatively close to the inlet 1460.

During use of the system 1000, the feed stream flows along its flow path through its sequence of components while the permeate stream flows along its flow path through its sequence of components, resulting in counter-flow of the feed stream and the permeate stream along respective surfaces of the membrane 1200. At the same time, the compressed gas source 1345 provides a flow of gas into the hollow fiber aerator 1340 so that the feed stream contains gas bubbles downstream of the aerator 1340, including when the feed stream contacts the surface of the membrane 1200 (see discussion below). Also at the same time, the compressed gas source 1445 provides a flow of gas into the hollow fiber aerator 1440 so that the permeate stream contains gas bubbles downstream of the aerator 1440, including when the permeate stream contacts the surface of the membrane 1200 (see discussion below). As the gas bubble-containing feed stream and the gas-bubble containing permeate stream counter-flow along the respective surfaces of the membrane 1200, water vapor is transferred from the relatively hot feed stream to the relatively cool feed stream, after which the feed stream and the permeate stream continue along their respective flow paths downstream of the module 1100.

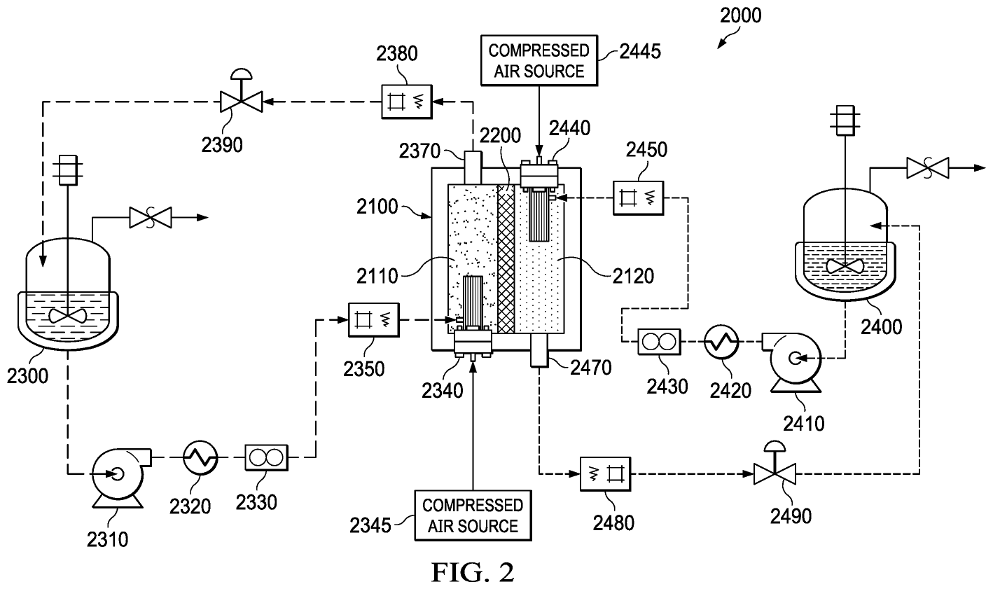

FIG. 2 is a schematic drawing of a direct contact membrane distillation system 2000. Corresponding components in systems 2000 and 1000 have the same last three digits in their reference numbers. For example, component 2400 in system 2000 corresponds to component 1400 in system 1000. A difference between system 2000 and system 1000 is that in system 2000 the hollow fiber aerators are embedded within module 2100 (typically such that each aerator is positioned relatively close to its respective membrane surface), whereas in system 1000 the hollow fiber aerators are outside the module 1100. However, like the system 1000, the system 2000 results in both the feed stream and the permeate stream containing air bubbles as they counter-flow along the respective surfaces of membrane 2200 such that water vapor is transferred from the relatively hot feed stream to the relatively cool feed stream. The direction of the flow path of the feed stream in system 2000 is the same as the direction of the flow path of the feed stream in system 1000, and the direction of the flow path of the permeate stream in system 2000 is the same as the direction of the flow path of the permeate stream in system 1000.

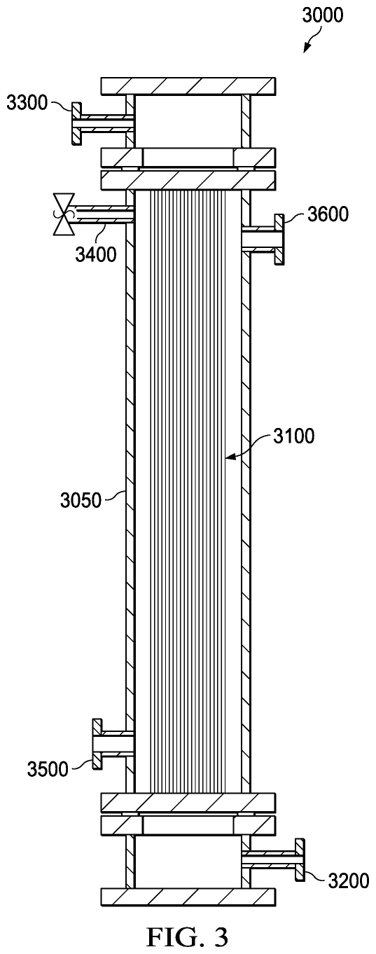

FIG. 3 schematically shows a hollow fiber aerator 3000 which includes a housing 3050, a plurality of porous hollow fibers 3100, a compressed gas inlet 3200, a compressed gas outlet 3300, a compressed gas head outlet 3400, a liquid stream inlet 3500, and a liquid stream outlet 3600. The liquid stream can be, for example, the feed stream or the permeate stream.

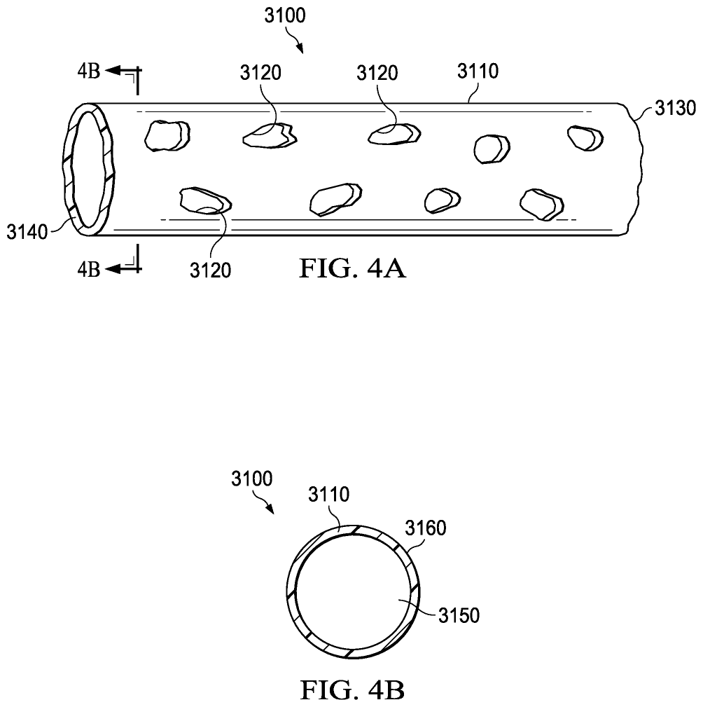

FIGS. 4A and 4B are a partial schematic perspective and a cross-sectional view of a hollow fiber 3100 that includes a wall 3110 with pores 3120, a first open end 3130, and a second open end 3140 such that the wall 3110 defines an interior 3150 of the fiber 3100 and an exterior 3160 of the fiber 3100.

Referring again to FIG. 3, during use of the hollow fiber aerator 3000, the liquid stream enters the aerator 3000 through the inlet 3500 and exits the aerator 3000 through the outlet 3600. At the same time, the compressed gas flows into the inlet 3200, through the first open end 3130 of each hollow fiber 3100 and into the interior 3150 of each hollow fiber 3100. Some of the gas in the interior 3150 of each hollow fiber 3100 leaves the hollow fiber 3100 through the second open end 3140 of the hollow fiber 3100 and exits the aerator 3000 through the outlet 3300. However, a portion of the air in the interior 3150 of each hollow fiber 3100 exits the hollow fiber 3100 through the pores 3120 in the wall 3110 of the hollow fiber 3100 in the form of air bubbles that enter the liquid stream as it flows through the aerator 3000 between the inlet 3500 and the outlet 3600. The result is that, although the liquid stream enters the aerator without containing air, the liquid stream exits the aerator 3000 containing air bubbles. The design of the aerator 3000 allows for continuous flow of the compressed gas during use of the aerator 3000. The compressed gas head outlet 3400 is generally closed during use of the aerator 3000, but the outlet 3400 can be opened as desired to release excess air pressure within the aerator 3000.

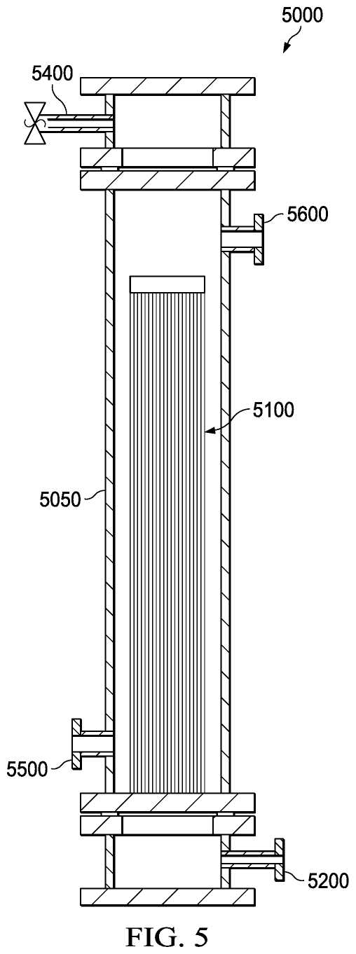

FIG. 5 schematically depicts an aerator 5000. A component in FIG. 5 with a reference numeral starting with the digit 5 corresponds to the component in FIG. 3 with a reference numeral starting with the digit 3. Corresponding components in the aerators 5000 and 3000 have the same last three digits in their reference numbers. For example, component 5200 in system 5000 corresponds to component 3200 in system 3000. A difference between the aerator 5000 and the aerator 3000 is that, while each hollow fiber 3100 in aerator 3000 has an open second end, each hollow fiber 5100 has a closed second end (e.g., plugged with an appropriate material). The result is that compressed gas that is in the interior of each hollow fiber 5100 leaves the interior of the hollow fiber 5100 only through the pores in the wall of the hollow fiber 5100. Another difference between the aerator 3000 and the aerator 5000 relates to the outlet for the compressed gas. In particular, the aerator 5000 does not include a component directly corresponding to the compressed gas outlet 3300 in the aerator 3000, and in the aerator 5000 the compressed gas head outlet 5400 is positioned similarly to the compressed gas outlet 3300 in aerator 3000. Despite these differences, like the aerator 3000, the net result of operation of the aerator 5000 is that, while the liquid stream does not contain air bubbles when it enters the aerator 5000, the liquid stream contains gas bubbles when it exits the aerator 5000.

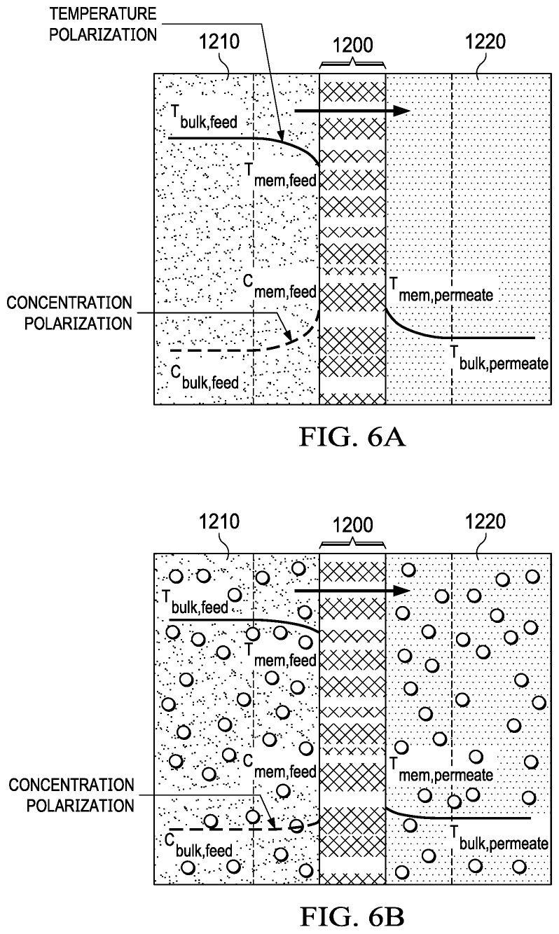

Without wishing to be bound by the subject matter shown in FIGS. 6A and 6B, these figures schematically depict an impact that is believed to be due to the presence of air bubbles in the permeate and feed streams. FIG. 6A schematically shows that, in the absence of gas bubbles in the feed stream, there is a relatively large amount of temperature polarization in the feed stream due to the relatively large difference between the bulk temperature of the feed stream and the temperature of the feed stream at the membrane surface. FIG. 6A also schematically shows that, in the absence of gas bubbles in the feed stream, there is a relatively large amount of concentration polarization in the feed stream due to the relatively large difference between the bulk concentration of the feed stream and the concentration of the feed stream at the membrane surface. FIG. 6A further schematically shows that, in the absence of air bubbles in the permeate stream, there is a relatively large amount of temperature polarization in the permeate stream due to the relatively large difference between the bulk temperature of the permeate stream and the temperature of the permeate stream at the membrane surface. FIG. 6B schematically shows that, in the presence of gas bubbles in the feed stream, there is a relatively small amount of temperature polarization in the feed stream due to the relatively small difference between the bulk temperature of the feed stream and the temperature of the feed stream at the membrane surface. FIG. 6B also schematically shows that, in the presence of gas bubbles in the feed stream, there is a relatively small amount of concentration polarization in the feed stream due to the relatively small difference between the bulk concentration of the feed stream and the concentration of the feed stream at the membrane surface. FIG. 6B further schematically shows that, in the presence of gas bubbles in the permeate stream, there is a relatively small amount of temperature polarization in the permeate stream due to the relatively small difference between the bulk temperature of the permeate stream and the temperature of the permeate stream at the membrane surface.

Certain features of some of the components in a membrane distillation system are now provided.

Generally, the membrane 1200 or 2200 can be formed of any appropriate material. In some embodiments, the membrane 1200 or 2200 is formed of an organic material, such as a polymer. Examples of polymers include polyvinylidenedifluoride (PVDF), polytetrafluoroethylene (PTFE or Teflon), polyethylene (PE), polypropylene (PP), polyetheretherketone (PEEK), polybenzimidazole (PBI). Additional examples of polymers include modified polymers to improve hydrophobicity by surface modification (e.g. direct fluorination or plasma treatment) or coating (dip coating or partial pore coating using diluted coating solution). In certain embodiments, the membrane 1200 or 2200 is formed of an inorganic material, such as a metal-containing material (e.g., palladium, silver or an alloy), a ceramic material (e.g., various oxides of alumina, titania or zirconia), a glass (e.g., silicon oxide or silica), a zeolite, or an inorganic carbon material. In some embodiments, the membrane 1200 or 2200 is formed of a mixed matrix material, such a material that is a mixture of an inorganic material and a polymeric material.

In general, the membrane 1200 or 2200 is microporous or mesoporous. In certain embodiments, the average size of the pores in the membrane 1200 or 2200 can be selected as desired. In some embodiments, the pores in the membrane 1200 or 2200 have an average size of at least 0.02 μm (e.g., at least 0.1 at least 0.5 μm) and/or at most 2 μm (e.g., at most 1.5 μm, at most 1 μm). In certain embodiments, the pores in the membrane 1200 or 2200 have an average size of from 0.02 μm to 2 μm (e.g., from 0.1 μm to 1.5 μm).

In general, the length of a hollow fiber aerator (e.g., a hollow fiber aerator used with the feed stream, a hollow fiber aerator used with the permeate stream) can be selected as desired. In some embodiments, the length of a hollow fiber aerator is at least 5% (e.g., at least 10%, at least 20%) and/or at most 50% (e.g., at most 40%, at most 30%) of the length of the module that contains the membrane 1200 or 2200. In certain embodiments, the length of a hollow fiber aerator is from 5% to 50% (e.g., from 10% to 50%, from 20% to 50%) of the length of the module that contains the membrane 1200 or 2200.

Generally, the material from which the hollow fibers in a hollow fiber aerator (e.g., a hollow fiber aerator for a feed stream, a hollow fiber aerator for a permeate stream) can be selected as desired. In some embodiments, the hollow fibers are formed of an organic material, such as a polymer. Examples of polymers include PSF, PES, PVDF, PAN, PTFE (e.g., Teflon), PAI, PI, a co-polyimide, PE, PP, CA, PEEK, and PBI and their modified form. In certain embodiments, the hollow fibers are formed of an inorganic material, such as a metal-containing material (e.g., palladium, silver or an alloy), a ceramic material (e.g., various oxides of alumina, titania or zirconia), a glass (e.g., silicon oxide or silica), a zeolite, or an inorganic carbon material. In some embodiments, the hollow fibers are formed of a mixed matrix material, such a material that is a mixture of an inorganic material and a polymeric material.

In general, the average size of the pores in the wall of a hollow fiber in a hollow fiber aerator (e.g., a hollow fiber aerator for a feed stream, a hollow fiber aerator for a permeate stream) can be selected as desired. In some embodiments, the pores have an average size of at least 0.02 μm (e.g., at least 0.1 μm, at least 0.5 μm) and/or at most 2 μm (e.g., at most 1.5 μm, at most 1 μm). In certain embodiments, the pores have an average size of from 0.02 μm to 2 μm (e.g., from 0.1 μm to 1.5 μm).

Generally, the average surface porosity of a hollow fiber in a hollow fiber aerator (e.g., a hollow fiber aerator for a feed stream, a hollow fiber aerator for a permeate stream) can be selected as desired. In some embodiments, the pores form at least 5% (e.g., at least 10%, at least 20%) and/or at most 60% (at most 50%, at most 40%) of the area of the surface area of the wall of a hollow fiber. In certain embodiments, the pores form from 5% to 60% (e.g., from 10% to 60%) of the area of the surface area of the wall of a hollow fiber.

In general, the overall porosity of the cross-sectional pores in the wall of a hollow fiber can be selected as desired. In some embodiments, the overall porosity of the cross-sectional pores of a hollow fiber is at least 30% (e.g., at least 40%, at least 50%) and/or at most 90% (e.g., at most 80%, at most 70%). In certain embodiments, the overall porosity of the cross-sectional pores of a hollow fiber is from 30% to 90% (e.g., from 40% to 90%).

In some embodiments, the gas bubbles in the permeate stream and/or the feed stream include microbubbles and/or nanobubbles. In certain embodiments, the bubbles have an average size of at least 50 μm (e.g., at least 100 μm, at least 150 μm) and/or an average size of at most 300 μm (e.g., at most 250 μm, at most 200 μm). In some embodiments, the bubbles have an average size of from 50 μm to 300 μm.

Without wishing to be bound by theory, it is believed that the bubble size can be controlled by taking into consideration the drag force (which can depend on the liquid velocity and liquid flow rate) and the capillary force (which can depend on the air pressure and the pore size) and compressed gas flow rate in given membrane surface porosity. It is believed that this information can be used to (empirically and/or theoretically) optimize mass transfer of a given feed stream to improve performance of the membrane distillation system.

While the disclosure has provided certain embodiments, the disclosure is not limited to such embodiments.

As an example, while systems have been disclosed in which hollow fiber aerators are provided on both the feed and permeate sides of the system, the disclosure is not limited to such systems. In some embodiments, a system includes a hollow fiber aerator on the permeate side but not on the feed side. In certain embodiments, a system includes a hollow fiber aerator on the feed side but not on the permeate side.

As another example, while air has been disclosed as gas from which the bubbles can be formed, more generally any appropriate gas can be used. Examples of such gases include nitrogen gas (N₂), nitrogen enriched air, oxygen (O₂) enriched air, and noble gases (helium, neon, krypton, argon, xenon).

As an additional example, while direct contact membrane distillation systems having one or more gas bubble sources have been described, the disclosure is not limited to such systems. More generally, one or more gas bubble sources can be present to provide gas bubbles to the feed stream in any appropriate membrane distillation system. Examples of such membrane distillation systems include vacuum membrane distillation (VIVID) systems, air gap membrane distillation (AGMD) systems, and sweeping gas membrane distillation (SGMD) systems.

As a further example, while certain process flow configurations have been disclosed, the disclosure is not limited to such configurations. In general, a process flow configuration can be a counter-current flow configuration or a co-current flow configuration.

Other embodiments are covered by the claims.

What is claimed is:

1. A membrane distillation system, comprising:
a housing, comprising:
a first container configured to allow a first liquid stream to pass therethrough;
a second container configured to allow a second liquid stream to pass therethrough, the second container being different from the first container, the second stream being different from the first liquid stream; and
a hydrophobic and porous membrane configured so that, during use of the system, the first liquid stream contacts a first side of the membrane and the second liquid stream contacts a second side of the membrane which is different from the first side of the membrane;
a first device configured to provide gas bubbles to the first liquid stream so that gas bubbles are present in the first liquid stream when the first liquid stream contacts the first side of the membrane; and
a second device configured to provide gas bubbles to the second liquid stream so that, during use of the system, the second liquid stream comprises gas bubbles when the second liquid stream contacts the second side of the membrane,
wherein:
the system is configured so that, during use of the membrane distillation system, the second liquid stream is hotter than the first liquid stream;
the gas bubbles in the second liquid stream reduce temperature polarization of the second liquid stream; and
the gas bubbles in the second liquid stream reduce concentration polarization of the second liquid stream.

2. The membrane distillation system of claim 1, wherein the first device comprises a hollow fiber aerator comprising a plurality of hollow fibers.

3. The membrane distillation system of claim 2, wherein each hollow fiber comprises a wall, and the wall comprises pores having an average size of from 0.02 μm to 2 μm.

4. The membrane distillation system of claim 2, wherein each hollow fiber comprises a wall having a surface area, and the wall comprises pores defining from 5% to 60% of the surface area of the wall.

5. The membrane distillation system of claim 1, wherein the system is a direct contact membrane distillation system.

6. The membrane distillation system of claim 1, wherein the first device is in the housing.

7. The membrane distillation system of claim 1, wherein the system is configured so that, during use of the system, the gas bubbles in the first liquid stream reduce temperature polarization of the first liquid stream.

8. The membrane distillation system of claim 1, wherein the gas bubbles have an average size of from 50 μm to 300 μm.

9. The membrane distillation system of claim 1, wherein the membrane comprises a polymer and the polymer comprises pores having an average size of from 0.02 μm to 2 μm.

10. The membrane distillation system of claim 1, wherein the second device comprises a second hollow fiber aerator.

11. The membrane distillation system of claim 1, wherein the second hollow fiber aerator is in the housing.

12. The membrane distillation system of claim 11, wherein the first and second devices are in the housing.

13. The membrane distillation system of claim 10, wherein the membrane distillation system is a direct contact membrane distillation system.

14. A membrane distillation system, comprising:
a housing, comprising:
a first container configured to allow a first liquid stream to pass therethrough;
a second container configured to allow a second liquid stream to pass therethrough, the second container being different from the first container, the second stream being different from the first liquid stream;
a hydrophobic and porous membrane configured so that, during use of the system, the first liquid stream contacts a first side of the membrane and the second liquid stream contacts a second side of the membrane which is different from the first side of the membrane;
a first hollow fiber aerator configured to provide gas bubbles to the first liquid stream so that gas bubbles are present in the first liquid stream when the first liquid stream contacts the first side of the membrane; and
a second hollow fiber aerator configured to provide gas bubbles to the second liquid stream so that gas bubbles are present in the second liquid stream when the second liquid stream contacts the first side of the membrane,
wherein:
the membrane distillation system is a direct contact membrane distillation system configured so that, during use of the direct contact membrane distillation system, the second liquid stream is hotter than the first liquid stream;
the gas bubbles in the second liquid stream reduce temperature polarization of the second liquid stream; and
the gas bubbles in the second liquid stream reduce concentration polarization of the second liquid stream.

15. A method, comprising:
introducing gas bubbles into a first liquid stream;
introducing gas bubbles into a second liquid stream different from the first liquid stream, the second liquid stream being hotter than the first liquid stream; and
after introducing gas bubbles into the first and second liquid streams, contacting a first side of a hydrophobic and porous membrane with the first liquid stream comprising the gas bubbles while simultaneously contacting a second side of the hydrophobic and porous membrane with the second liquid stream comprising gas bubbles,
wherein:
the first side of the membrane is opposite from the second side of the membrane;
the gas bubbles in the second liquid stream reduce a temperature polarization in the second liquid stream; and
the gas bubbles in the second liquid stream reduce a concentration polarization in the second liquid stream.

16. The method of claim 15, further comprising using a hollow fiber aerator to introduce the gas bubbles into the first liquid stream.

17. The method of claim 15, further comprising using a hollow fiber aerator to introduce the gas bubbles into the first liquid stream.

18. The method of claim 17, wherein the method is used to treat produced water.

19. The method of claim 17, wherein the method is in a produced water desalination process.

20. The method of claim 15, further comprising:
using a first hollow fiber aerator to introduce the gas bubbles into the first liquid stream;
using a hollow fiber aerator to introduce the gas bubbles into the first liquid stream; and
using the method to desalinate produced water.
